(19) United States
(12) Patent Application Publication
(10) Pub. No.: US 2016/0307110 A1
(43) Pub. Date: Oct. 20, 2016

(54) ARCHIVING SYSTEMS AND METHODS USING MESSAGE CATEGORIZATION AND CLASSIFICATION PROCESSES

(71) Applicant: Data Storage Corporation, Garden City, NY (US)

(72) Inventor: Stephen Catanzano, Garden City, NY (US)

(73) Assignee: Data Storage Corporation, Garden City, NY (US)

(21) Appl. No.: 14/688,472

(22) Filed: Apr. 16, 2015

(51) Int. Cl. G06N 7/00; G06F 17/30

(52) U.S. Cl. CPC G06N 7/005; G06F 17/30598

(57) ABSTRACT

A method is presented for archiving messages, the method including receiving a plurality of messages from a plurality of computing devices via a network, analyzing each of the plurality of messages, creating a full text index for each of the plurality of messages, executing a probabilistic classifier, comparing the full text index of each of the plurality of messages to a plurality of classifications, applying a tag classifier to each message of the plurality of messages based on an identified classification from the plurality of classifications and categorizing each tag classifier into one or more of a plurality of categories.

### BACKGROUND

1. Technical Field

The present disclosure relates to information archiving methods and systems. More particularly, the present disclosure relates to archiving methods and systems for analyzing, classifying, and categorizing messages, such as emails.

2. Description of Related Art

In this age of computers and the Internet, organizations and individuals are incessantly inundated by a plethora of information. For organizations, much of the information is communicated in the form of electronic mail (referred as “e-mail” or “email”). Since its introduction as a form of communication, emails have become one of the most preferred methods of communication, often preferred over phone calls, meetings, etc. As a result, a significant portion of an employee's workday is spent reading, writing, and organizing emails.

The increased use of email also means that more and more information, of all types, is communicated and memorialized in the form of emails. This makes email an important part of electronic documents for organizations, requiring organizations and employees to pay more attention to policies and procedures related to archival of emails. As email systems continue to grow, more and more companies are turning their attention to email management. Moreover, legal departments are increasingly focused on e-discovery, record managers want email records under control, and management experts want emails to be compliant with industry and other regulations. This is especially true in view of various new regulations, such as the Sarbanes-Oxley Act, which mandates specified levels of document management and archival by companies. Furthermore, electronic documentation discovery has become an increasingly important part of lawsuits, as exemplified by the increasing number of legal cases being determined based on information communicated over emails. This adds additional pressure on organizations to come up with a coherent and comprehensive email management policy.

Organizations have generally reacted to such needs in one of two manners. Some organizations end up with an over-reactive electronic document retention policy that requires keeping all electronic documents, including all emails, for a long time, sometimes forever. In such a case, every single piece of email, including emails between employees and their friends and families, etc., end up being stored as part of the archives. Such overly cautious document retention policy results in email inboxes and archival systems becoming too large and cumbersome to manage. Furthermore, it becomes overly costly and time consuming to find any relevant information from such “save everything” document archive.

On the other hand, various other organizations implement a policy that mandates employees to remove most of the emails, at least from their in-boxes. Generally, under such policies, companies set quotas in the form of size of email that can be saved in in-boxes, often at several megabytes. Such an overly strict “save nothing” type of email management policies often result in inconvenience to employees as they have to constantly keep cleaning their email in-boxes. Moreover, as employees are forced to constantly clean out their emails, they often end up deleting emails without reading or deleting emails that are important for the organizations. As expected, such policies often end up being counterproductive and may cause problems at a later stage when it becomes almost impossible to find information that is important to organizations and their employees.

Thus, there is a need for a method and system that assists organizations and employees in managing their emails in an efficient and effective manner.

### SUMMARY

Embodiments of the present disclosure are described in detail with reference to the drawing figures wherein like reference numerals identify similar or identical elements.

An aspect of the present disclosure provides a method for archiving messages, the method including receiving a plurality of messages from a plurality of computing devices via a network, analyzing each of the plurality of messages, creating a full text index for each of the plurality of messages, executing a probabilistic classifier, comparing the full text index of each of the plurality of messages to a plurality of classifications, applying a tag classifier to each message of the plurality of messages based on an identified classification from the plurality of classifications and categorizing each tag classifier into one or more of a plurality of categories.

In one aspect, the analyzing step includes analyzing body text, headers, hidden text, and attachments of each of the plurality of messages.

In another aspect, the comparing step uses language models, pattern matching, and power search with words list to classify each of the plurality of messages.

In yet another aspect, a classification rule is applied to each of the plurality of messages associated with the identified classification.

In one aspect, a relevance score is applied to each of the plurality of messages associated with the identified classification. The relevance score is compared to a threshold score for each category of the plurality of categories.

In another aspect, a real-time alert is provided after each tag classifier is categorized into a category of the plurality of categories. The real-time alert is based on a predetermined classification rule. Further, an action may be automatically generated based on the real-time alert.

In yet another aspect, a plurality of classifications rules are created based on one or more of the plurality of categories.

In yet another aspect, the plurality of messages are at least one of emails, instant messages, text messages, inmails, and social media communications.

Another aspect of the present disclosure provides a system for archiving messages, the system including a network having one or more communication channels, a plurality of computing devices communicating with the network, each of the plurality of computing devices configured to send a plurality of messages, and a computer program stored in a memory and operable to cause a processor to execute a plurality of steps. The steps include analyzing each of the plurality of messages, creating a full text index for each of the plurality of messages, executing a probabilistic classifier, comparing the full text index of each of the plurality of messages to a plurality of classifications, applying a tag classifier to each message of the plurality of messages based on an identified classification from the plurality of classifications and categorizing each tag classifier into one or more of a plurality of categories.

Certain embodiments of the present disclosure may include some, all, or none of the above advantages and/or one or more other advantages readily apparent to those skilled in the art from the drawings, descriptions, and claims included herein. Moreover, while specific advantages have been enumerated above, the various embodiments of the present disclosure may include all, some, or none of the enumerated advantages and/or other advantages not specifically enumerated above.

### BRIEF DESCRIPTION OF THE DRAWING

Various embodiments of the present disclosure are described herein below with references to the drawings, wherein:

FIG. 1 is a system for archiving messages, such as emails, in accordance with embodiments of the present disclosure;

FIG. 2 is a network having a plurality of communication channels for communicating with a plurality of computing devices to receive a plurality of messages therefrom, in accordance with embodiments of the present disclosure;

FIG. 3 is a flowchart depicting a process for archiving messages, in accordance with embodiments of the present disclosure;

FIG. 4 illustrates an analytic supervision and tab categories, in accordance with embodiments of the present disclosure;

FIG. 5 illustrates a table of policies for modifying one or more categories or subcategories, in accordance with embodiments of the present disclosure; and

FIG. 6 illustrates dialog boxes enabling a user to modify one or more alerts to be sent to one or more individuals, in accordance with embodiments of the present disclosure.

The figures depict embodiments of the present disclosure for purposes of illustration only. One skilled in the art will readily recognize from the following disclosure that alternative embodiments of the structures and methods illustrated herein may be employed without departing from the principles of the present disclosure described herein.

### DETAILED DESCRIPTION

Although the present disclosure will be described in terms of specific embodiments, it will be readily apparent to those skilled in this art that various modifications, rearrangements and substitutions may be made without departing from the spirit of the present disclosure. The scope of the present disclosure is defined by the claims appended hereto.

For the purposes of promoting an understanding of the principles of the present disclosure, reference will now be made to the exemplary embodiments illustrated in the drawings, and specific language will be used to describe the same. It will nevertheless be understood that no limitation of the scope of the present disclosure is thereby intended. Any alterations and further modifications of the inventive features illustrated herein, and any additional applications of the principles of the present disclosure as illustrated herein, which would occur to one skilled in the relevant art and having possession of this disclosure, are to be considered within the scope of the present disclosure.

The word “exemplary” is used herein to mean “serving as an example, instance, or illustration.” Any embodiment described herein as “exemplary” is not necessarily to be construed as preferred or advantageous over other embodiments. The word “example” may be used interchangeably with the term “exemplary.”

The term “processing” may refer to determining the elements or essential features or functions or processes of one or more archiving systems for computational processing. The term “process” may further refer to tracking data and/or collecting data and/or manipulating data and/or examining data and/or updating data on a real-time basis in an automatic manner and/or a selective manner and/or manual manner.

The term “analyze” may refer to determining the elements or essential features or functions or processes of one or more analyzing systems for computational processing. The term “analyze” may further refer to tracking data and/or collecting data and/or manipulating data and/or examining data and/or updating data on a real-time basis in an automatic manner and/or a selective manner and/or manual manner. The term “analyze” may refer to at least decoding or deconstructing or assessing or evaluating or examining or assorting or arranging or cataloging or codifying or indexing or sorting or tabulating or dissecting at least data/information/messages.

The term “storage” may refer to data storage. “Data storage” may refer to any article or material (e.g., a hard disk) from which information may be capable of being reproduced, with or without the aid of any other article or device. “Data storage” may refer to the holding of data in an electromagnetic form for access by a computer processor. Primary storage may be data in random access memory (RAM) and other “built-in” devices. Secondary storage may be data on hard disk, tapes, and other external devices. “Data storage” may also refer to the permanent holding place for digital data, until purposely erased. “Storage” implies a repository that retains its content without power. “Storage” mostly means magnetic disks, magnetic tapes and optical discs (CD, DVD, etc.). “Storage” may also refer to non-volatile memory chips such as flash, Read-Only memory (ROM) and/or Electrically Erasable Programmable Read-Only Memory (EEPROM).

The term “module” or “unit” may refer to a self-contained component (unit or item) that may be used in combination with other components and/or a separate and distinct unit of hardware or software that may be used as a component in a system, such as a message/email archiving system. The term “module” may also refer to a self-contained assembly of electronic components and circuitry, such as a stage in a computer that may be installed as a unit. The term “module” may be used interchangeably with the term “unit.”

The term “message” may refer to at least emails, instant messages, text messages, inmails, and social media communications. For instance, LinkedIn™ has an Inmail™ feature that allows users to contact or be directly contacted by other LinkedIn™ users. Social media communications may be communications between, for example, Facebook™ users. The term “message” may refer to any type of electronic communication either between users or between a user and an electronic device or between electronic devices. The term “message” may refer to the transmission and reception of any type of electronic messages.

The exemplary embodiments of the present disclosure relate to archiving systems. In particular, the exemplary embodiments of the present disclosure relate to message/email archiving systems. The archiving systems of the present disclosure capture and analyze different types of messages, data, information, and place such messages, data, information into a plurality of categories. A category may be thought of as a folder containing relevant messages that meet predefined or predetermined criteria for a category. The archiving systems of the present disclosure look at every message, including the body text, headers, hidden text, and any attachment text. Each message is categorized according to one or more techniques. The first technique involves using proprietary language models. The second technique involves power searching with word lists. The third technique involves using pattern matching. A combination of these techniques may be used.

Concerning the proprietary language model technique, when the archiving system processes a message, the archiving system compares the message to the language models and performs a complex analysis to determine if the message falls into one of a plurality of categories and measures. There may be hundreds if not thousands of predetermined categories and measures. Categories and measures may also be customized by a user. Each message is analyzed in its entirety, not just for individual word matches. As mentioned above, the analysis includes the message body text, headers, attachments, and hidden text.

Concerning the power searching with word lists technique, the archiving system includes word lists and customer generated word lists. The customer generated word lists may be built from a plurality of customer data/information received over a period of time.

Concerning the pattern matching technique, one or more pattern matching algorithms may be used to analyze words within a message, such as an email. Pattern recognition systems are in many cases trained from labeled “training” data (supervised learning), but when no labeled data are available, other algorithms may be used to discover previously unknown patterns (unsupervised learning). The terms pattern recognition, machine learning, data mining and knowledge discovery in databases (KDD) are hard to separate, as they largely overlap in their scope.

Pattern recognition algorithms generally aim to provide a reasonable answer for all possible inputs and to perform “most likely” matching of the inputs, taking into account their statistical variation. This is opposed to pattern matching algorithms, which look for exact matches in the input with pre-existing patterns. A common example of a pattern-matching algorithm is regular expression matching, which looks for patterns of a given sort in textual data and is included in the search capabilities of many text editors and word processors. In contrast to pattern recognition, pattern matching is generally not considered a type of machine learning, although pattern-matching algorithms can sometimes succeed in providing similar-quality output to the sort provided by pattern-recognition algorithms. Thus, pattern matching is the act of checking a given sequence of tokens for the presence of the constituents of some pattern. The patterns generally have the form of either sequences or tree structures. Uses of pattern matching include outputting the locations (if any) of a pattern within a token sequence, to output some component of the matched pattern, and to substitute the matching pattern with some other token sequence.

Reference will now be made in detail to embodiments of the present disclosure. While certain exemplary embodiments of the present disclosure will be described, it will be understood that it is not intended to limit the embodiments of the present disclosure to those described embodiments. To the contrary, reference to embodiments of the present disclosure is intended to cover alternatives, modifications, and equivalents as may be included within the spirit and scope of the embodiments of the present disclosure as defined by the appended claims.

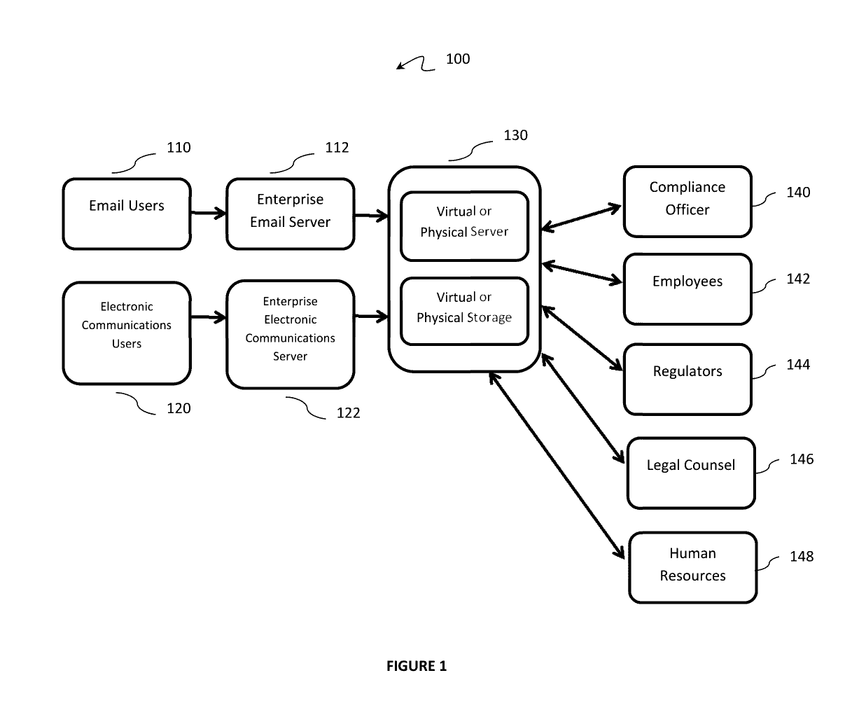

FIG. 1 is a system 100 for archiving messages, such as emails, in accordance with embodiments of the present disclosure.

The system 100 includes a plurality of email users 110 that send a plurality of emails to a storage module 130 via an enterprise email server 112. The system 100 further includes a plurality of electronic communications users 120 that send a plurality of electronic communications to the storage module 130 via an enterprise electronic communications server 130. The electronic communications may be, for example, IM messages. However, one skilled in the art may contemplate any types of messages. The storage module 130 may include, for example, a virtual or physical server and/or a virtual or physical storage. The storage module 130 may communicate such emails/messages to, for example, a compliance officer 140, employees 142, regulators 144, legal counsel 146, and human resources 148. One skilled in the art may contemplate sending such emails/messages to a plurality of external sources and/or individuals.

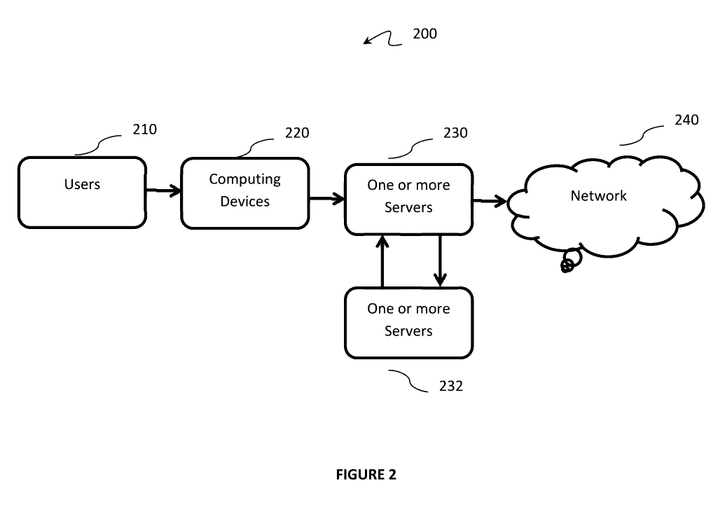

FIG. 2 is a network having a plurality of communication channels for communicating with a plurality of computing devices to receive a plurality of emails therefrom, in accordance with embodiments of the present disclosure.

FIG. 2 illustrates an embodiment of a document management system 200 wherein one or more email/IM servers 230 may be communicatively connected to a network 240, such as the Internet, and with one or more client computers or computing devices 220. The one or more email/IM servers 230 may receive data/information from network 240 and forward such data/information based on, for example, the addressee information in an email, to one of the target clients, such as one of the computing devices 220 handled by a plurality of users 210. Similarly, the client at computing devices 220 may send, for example, an email to a recipient that may be connected to the network 240 via the one or more servers 230. The one or more email/IM servers 230 may include an electronic document classification module to classify emails and to send the classified emails to the client computers. In an alternate embodiment, the client computers may also include an electronic document classification module to classify emails and to display the classified emails to a user. In another exemplary embodiment, the one or more servers 230 may communicate with another set of servers 232.

Network 240 may be a group of interconnected (via cable and/or wireless) computers, databases, servers, routers, and/or peripherals that are capable of sharing software and hardware resources between many users. The Internet is a global network of networks. Network 240 may be a communications network. Thus, network 240 may be a system that enables users of data communications lines to exchange information over long distances by connecting with each other through a system of routers, servers, switches, databases, and the like.

Network 240 may include a plurality of communication channels. The communication channels refer either to a physical transmission medium such as a wire or to a logical connection over a multiplexed medium, such as a radio channel. A channel is used to convey an information signal, for example a digital bit stream, from one or several senders (or transmitters) to one or several receivers. A channel has a certain capacity for transmitting information, often measured by its bandwidth. Communicating data from one location to another requires some form of pathway or medium. These pathways, called communication channels, use two types of media: cable (twisted-pair wire, cable, and fiber-optic cable) and broadcast (microwave, satellite, radio, and infrared). Cable or wire line media use physical wires of cables to transmit data and information. The communication channels are part of network 240.

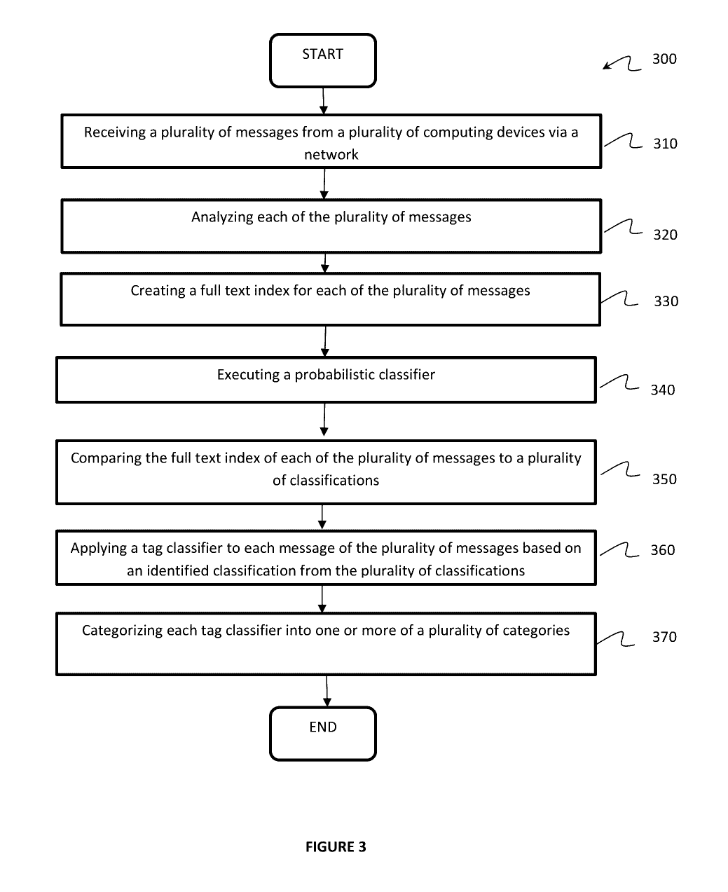

FIG. 3 is a flowchart depicting a process for archiving messages, such as email, in accordance with embodiments of the present disclosure.

The flowchart 300 includes the following steps. In step 310, a plurality of emails are received from a plurality of computing devices via a network. In step 320, each of the plurality of emails are analyzed or decoded or deconstructed. In step 330, a full text index is created for each of the plurality of emails. In step 340, a probabilistic classifier is executed. In step 350, the full text index of each of the plurality of emails is compared to a plurality of classifications. In step 360, a tag classifier is applied to each email of the plurality of emails based on an identified classification from the plurality of classifications. In step 370, each tag classifier is categorized into one or more of a plurality of categories.

The process then ends. It is to be understood that the method steps described herein need not necessarily be performed in the order as described. Further, words such as “thereafter,” “then,” “next,” etc., are not intended to limit the order of the steps. These words are simply used to guide the reader through the description of the method steps.

Additionally, with reference to FIGS. 1-3, once the analysis is complete, the message is scored for each of the plurality of categories and measures, including, for example, privacy, presence of sensitive data (e.g., social security numbers), confidential information, user-defined categories, and offensive content (potentially harassing content). The relevant score for each message is compared to a threshold score for each category or measure. When a message's score exceeds the predetermined threshold, it is then placed into that category. The message may be placed in more than one category.

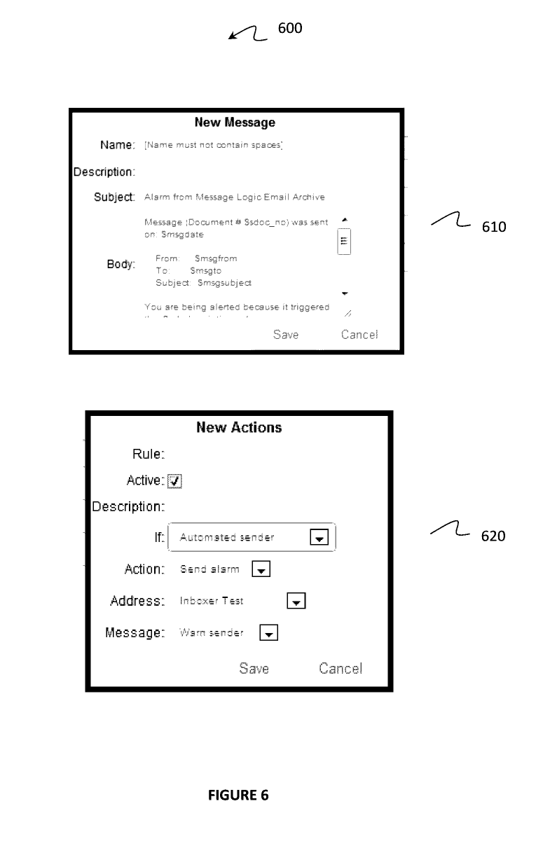

Moreover, the archiving system of the present disclosure provides for real-time alerts, as described below with reference to FIG. 6. The real-time alerts provide for an early warning system for potential problems. Once the message is categorized, the archiving system sends a customer email to the sender, the recipient, administrators, human resources, security personnel, and/or any other third party. Several actions may be taken in response to the real-time alerts.

These actions can be taken based on rules that are created based on categories or combinations of categories. For example, a rule may be created that would be triggered if a word from a word list was used (one category) and the message was from an external domain (another category). Actions would also be established for each rule. Such actions, may include, but are not limited to, forwarding the message to a third-party. Multiple actions may be taken for each rule. For example, a message may be forwarded to human resources or a compliance officer. The sender may also be contacted of such action. Further, the content of the forwarding cover message text and subject line may be predefined or predetermined for each action and each category rule. For example, a message sent to the sender may be different than the one sent to the compliance officer. Each message may include variable or different content.

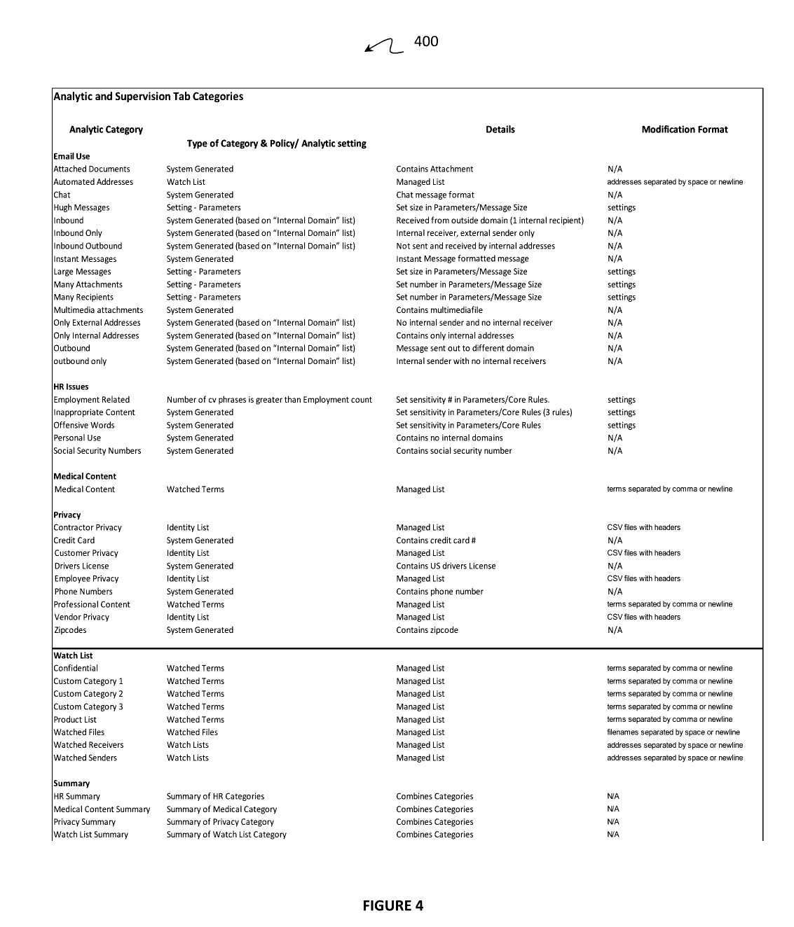

FIG. 4 illustrates an analytic supervision and tab categories table 400, in accordance with embodiments of the present disclosure.

FIG. 4 depicts a plurality of analytic categories, such as an email use category, an HR issues category, a medical content category, a watch list category, and a summary category. Each category may include a plurality of subcategories. For example, the email use category has several subcategories, such as attached documents, automated addresses, chat, huge messages, inbound, outbound, inbound only, outbound only, etc. Each subcategory has an analytic setting associated therewith. Each subcategory also includes a detailed description associated therewith. Therefore, incoming messages are broken down into a plurality of categories and each category includes a plurality of subcategories, where each subcategory includes further information/data pertaining to each incoming message. In other words, each incoming message is analyzed and dissected into a plurality of parts or pieces, and stored in, for example, a table format 400. Of course one skilled in the art may contemplate a plurality of different formats for storing such information/data collected from dissecting each and every incoming message.

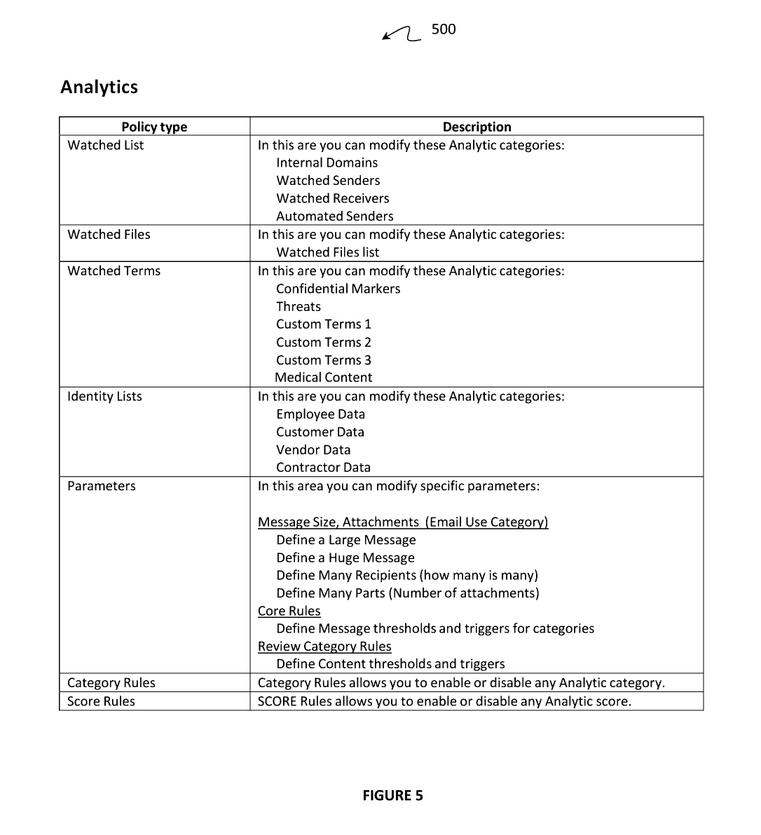

FIG. 5 illustrates a table of policies 500 for modifying one or more categories or subcategories, in accordance with embodiments of the present disclosure.

Table 500 illustrates a plurality of policies, such as watched list, watched files, watched terms, identity lists, parameters, category rules, and score rules. A description is provided for each policy of the plurality of policies. For example, the description of the watched list policy indicates which categories may be modified by a user or administrator or authorized individual. For example, in this case, the internal domains category, the watched senders' category, the watched receivers' category, and the automated senders' category may be modified. One skilled in the art may contemplate enabling a plurality of different policies to be listed and a plurality of different categories within each policy permitted to be modified.

FIG. 6 illustrates dialog boxes 600 enabling a user to modify one or more alerts to be sent to one or more individuals, in accordance with embodiments of the present disclosure.

Dialog box 610 is a new message dialog box that allows a user to create customized messages based on certain alerts, whereas dialog box 620 is a new action dialog box that allows a user to create custom rules in view of those alerts. Alerts allow a user to create custom messages and apply custom rules to messages in the archiving system identifying when and whom to send the custom message to. For instance, this is a tool that may be used for enforcing corporate polices. In dialog box 610, a generic reminder or warning message or something specific to a message one wants to convey may be created. In dialog box 620, one can establish a rule to trigger an alert if a message triggers a category. A user can select a message which was created with dialog box 610 and define to whom that user wants this message to go to.

In use, in one exemplary embodiment, the archiving system of the present disclosure receives a message, such as, but not limited to, an email. The email is analyzed. The analysis may be accomplished by one or more of the three techniques discussed above. The message is indexed so that it can be searchable. The email is identified as including a social security number therein. A classifier tag is assigned or associated with the email. The classifier tag may be, for example, “HasSSN tag.” Of course, one skilled in the art may contemplate any type of designation. The message is then moved into a database or category associated with social security numbers. For example, the message may be moved into the “Social Security Analytic Category.”

Once this action takes place, an alert may be sent to the sender, the receiver, and/or a manager. The message may be a pre-established message, such as, “Your last email contained a social security number. Please refrain from sending messages with such content in the future.” Of course, a different pre-established message may be sent to other external sources. Therefore, one categorization of an email may trigger different messages to different individuals. Additionally, such message may be stored in more than one category based on the content within the message. Also, the category selected may be further refined by a plurality of different variables. For example, the category itself is a dynamic category that may be further refined, updated, modified, continuously and in real-time, based on the messages that are received. The category itself may be further modified into a plurality of sub-categories.

It is contemplated that many of the analytics are pre-programmed in the archiving system with the ability to be modified. Other analytics may be designed to be customizable with a user's or organizations' own criteria or the capability of creating new analytics specific to a user's or organizations' requirements.

The predefined or predetermined or pre-established categories may include an automated address category, only internal address category, inbound category, outbound category, inbound only category, outbound only category, social security category, chat category, phone number category, driver's license category, credit card category, zip code category, inappropriate content category, offensive words category, personal use category, employment related category, professional content category, large message category, huge message category, attachments category, multimedia attachments category, many recipients category, many attachments category, attached documents category, HR issues category, legal issues category, privacy issues category, employee data category, customer data category, vendor data category, contractor data category, confidential category, trading terms category, watched sender category, watched receiver category, watched file category, and several other custom categories. One skilled in the art may contemplate a plurality of different categories and subcategories (hundreds or even thousands).

Therefore, in summary, the archiving system of the present disclosure analyzes documents and information attached to the documents or data or information or emails or IM messages or messages in general. The messages are each assigned a classifier tag based on classification rules. The messages are then stored in one or more categories based on the assigned classifier tags. Therefore, each message may receive more than one classifier tag. Thus, categorized data is generated. The categorized data may be further refined. The categorized data is updated continuously and in real-time. The classifier is a probabilistic classifier. The probabilistic classifier is a classifier that is able to predict, given a sample input, a probability distribution over a set of classes, rather than only predicting a class for the sample. Probabilistic classifiers provide classification with a degree of certainty, which can be useful in its own right or when combining classifiers into ensembles.

Stated differently, messages from electronic communications are collected and treated as corporate records. The messages are indexed so that they become searchable documents. The documents may be retained for a predefined period of time and the documents may be removed after the predefined period of time expires. A means for searching and producing the documents as evidence is also presented. However, further levels of intelligence are embedded within such archiving system. For example, a plurality of classification categories are built into the archiving system. The categories are built on patterns, word matching, and measurements. Some of the categories are fixed, while others are fully modifiable or customizable by one or more authorized users. Custom categories may be created based on the needs of the user or organization. Documents or messages may be tagged with multiple classifications. The classification of a message is something that allows a user or organization to create real-time alerts to one or more individuals, including the sender and recipient. A pre-programmed message may be sent if the classification is triggered. Thus, each message or document is classified and categorized based on the use of one or more techniques.

The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program or computer program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, tablets, portable/personal digital assistants, and other devices that facilitate communication of information between end-users within a network.

The general features and aspects of the present disclosure remain generally consistent regardless of the particular purpose. Further, the features and aspects of the present disclosure may be implemented in system in any suitable fashion, e.g., via the hardware and software configuration of system or using any other suitable software, firmware, and/or hardware.

For instance, when implemented via executable instructions, various elements of the present disclosure are in essence the code defining the operations of such various elements. The executable instructions or code may be obtained from a readable medium (e.g., a hard drive media, optical media, EPROM, EEPROM, tape media, cartridge media, flash memory, ROM, memory stick, and/or the like) or communicated via a data signal from a communication medium (e.g., the Internet). In fact, readable media may include any medium that may store or transfer information.

According to one embodiment of the present disclosure, the components, process steps, and/or data structures disclosed herein may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, connections and networks, data stores, or a stand-alone device. The process can be implemented as instructions executed by such hardware, hardware alone, or any combination thereof. The software may be stored on a program storage device readable by a machine.

The computer means or computing means or processing means may be operatively associated with the archiving system, and is directed by software to compare the first output signal with a first control image and the second output signal with a second control image. The software further directs the computer to produce diagnostic output. Further, a means for transmitting the diagnostic output to an operator of the verification device is included. Thus, many applications of the present disclosure could be formulated. The exemplary network disclosed herein may include any system for exchanging data or transacting business, such as the Internet, an intranet, an extranet, WAN (wide area network), LAN (local area network), satellite communications, and/or the like. It is noted that the network may be implemented as other types of networks.

Additionally, “code” as used herein, or “program” as used herein, may be any plurality of binary values or any executable, interpreted or compiled code which may be used by a computer or execution device to perform a task. This code or program may be written in any one of several known computer languages. A “computer,” as used herein, may mean any device which stores, processes, routes, manipulates, or performs like operation on data. A “computer” may be incorporated within one or more transponder recognition and collection systems or servers to operate one or more processors to run the transponder recognition algorithms. Moreover, computer-executable instructions include, for example, instructions and data which cause a general purpose computer, special purpose computer, or special purpose processing device to perform a certain function or group of functions. Computer-executable instructions also include program modules that may be executed by computers in stand-alone or network environments. Generally, program modules include routines, programs, objects, components, and data structures, etc., that perform particular tasks or implement particular abstract data types.

According to one embodiment of the present disclosure, the components, processes and/or data structures may be implemented using machine language, assembler, C or C++, Java and/or other high level language programs running on a data processing computer such as a personal computer, workstation computer, mainframe computer, or high performance server running an OS such as Solaris® available from Sun Microsystems, Inc. of Santa Clara, Calif., Windows Vista™, Windows NT®, Windows XP PRO, and Windows® 2000, available from Microsoft Corporation of Redmond, Wash., Apple OS X-based systems, available from Apple Inc. of Cupertino, Calif., or various versions of the Unix operating system such as Linux available from a number of vendors. The method may also be implemented on a multiple-processor system, or in a computing environment including various peripherals such as input devices, output devices, displays, pointing devices, memories, storage devices, media interfaces for transferring data to and from the processor(s), and the like. In addition, such a computer system or computing environment may be networked locally, or over the Internet or other networks. Different implementations may be used and may include other types of operating systems, computing platforms, computer programs, firmware, computer languages and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

Persons skilled in the art will understand that the devices and methods specifically described herein and illustrated in the accompanying drawings are non-limiting exemplary embodiments. The features illustrated or described in connection with one exemplary embodiment may be combined with the features of other embodiments. Such modifications and variations are intended to be included within the scope of the present disclosure.

The foregoing examples illustrate various aspects of the present disclosure and practice of the methods of the present disclosure. The examples are not intended to provide an exhaustive description of the many different embodiments of the present disclosure. Thus, although the foregoing present disclosure has been described in some detail by way of illustration and example for purposes of clarity and understanding, those of ordinary skill in the art will realize readily that many changes and modifications may be made thereto without departing form the spirit or scope of the present disclosure.

While several embodiments of the disclosure have been shown in the drawings and described in detail hereinabove, it is not intended that the disclosure be limited thereto, as it is intended that the disclosure be as broad in scope as the art will allow. Therefore, the above description and appended drawings should not be construed as limiting, but merely as exemplifications of particular embodiments. Those skilled in the art will envision other modifications within the scope and spirit of the claims appended hereto.

What is claimed is:

1. A method for archiving messages, the method comprising:
receiving a plurality of messages from a plurality of computing devices via a network;
analyzing each of the plurality of messages;
creating a full text index for each of the plurality of messages;
executing a probabilistic classifier;
comparing the full text index of each of the plurality of messages to a plurality of classifications;
applying a tag classifier to each message of the plurality of messages based on an identified classification from the plurality of classifications; and
categorizing each tag classifier into one or more of a plurality of categories.

2. The method of claim 1, wherein the analyzing step includes analyzing body text, headers, hidden text, and attachments of each of the plurality of messages.

3. The method of claim 1, wherein the comparing step uses language models, pattern matching, and power search with words list to classify each of the plurality of messages.

4. The method of claim 1, further comprising applying a classification rule to each of the plurality of messages associated with the identified classification.

5. The method of claim 1, further comprising applying a relevance score to each of the plurality of messages associated with the identified classification.

6. The method of claim 5, wherein the relevance score is compared to a threshold score for each category of the plurality of categories.

7. The method of claim 1, further comprising providing a real-time alert after each tag classifier is categorized into a category of the plurality of categories.

8. The method of claim 7, wherein the real-time alert is based on a predetermined classification rule.

9. The method of claim 8, wherein an action is automatically generated based on the real-time alert.

10. The method of claim 1, wherein the plurality of messages are at least one of emails, instant messages, text messages, inmails, and social media communications.

11. A system for archiving messages, the system comprising:
a network having one or more communication channels;
a plurality of computing devices communicating with the network, each of the plurality of computing devices configured to send a plurality of messages;
a computer program stored in a memory and operable to cause a processor to:
analyze each of the plurality of messages;
create a full text index for each of the plurality of messages;
execute a probabilistic classifier;
compare the full text index of each of the plurality of messages to a plurality of classifications;
apply a tag classifier to each message of the plurality of messages based on an identified classification from the plurality of classifications; and
categorize each tag classifier into one or more of a plurality of categories.

12. The system of claim 11, wherein the analyzing step includes analyzing body text, headers, hidden text, and attachments of each of the plurality of messages.

13. The system of claim 11, wherein the comparing step uses language models, pattern matching, and power search with words list to classify each of the plurality of messages.

14. The system of claim 11, further comprising applying a classification rule to each of the plurality of messages associated with the identified classification.

15. The system of claim 11, further comprising applying a relevance score to each of the plurality of messages associated with the identified classification.

16. The system of claim 15, wherein the relevance score is compared to a threshold score for each category of the plurality of categories.

17. The system of claim 11, further comprising providing a real-time alert after each tag classifier is categorized into a category of the plurality of categories.

18. The system of claim 17, wherein the real-time alert is based on a predetermined classification rule.

19. The system of claim 18, wherein an action is automatically generated based on the real-time alert.

20. The system of claim 11, wherein the plurality of messages are at least one of emails, instant messages, text messages, inmails, and social media communications.
